(19) United States
(12) Patent Application Publication
(10) Pub. No.: US 2017/0165813 A1
(43) Pub. Date: Jun. 15, 2017

(54) Illumination structure for pliers

(71) Applicant: Shih Cheng WANG, Taichung City (TW)

(72) Inventor: Shih Cheng WANG, Taichung City (TW)

(21) Appl. No.: 14/967,405

(22) Filed: Dec. 14, 2015

(51) Int. Cl. B25B 7/22; F21V 23/04; F21V 33/00

(52) U.S. Cl. CPC B25B 7/22; F21V 33/0084; F21V 23/04

(57) ABSTRACT

An illumination structure for pliers contains: a first part, a second part, and an illumination device. The first part includes a first clamping jaw, a first handle, and a first rotatable connecting portion between the first clamping jaw and the first handle. The second part includes a second clamping jaw, a second handle, and a second rotatable connecting portion between the second clamping jaw and the second handle, wherein the first rotatable connecting portion of the first part and the second rotatable connecting portion of the second part are rotatably connected together. The first rotatable connecting portion has an accommodation groove configured to house the illumination device, and the accommodation groove has a first opening communicating with the first clamping jaw and the second clamping jaw and has a second opening communicating with the first handle. The illumination device includes a light emitting element and a control button.

### FIELD OF THE INVENTION

The present invention relates to an illumination structure for pliers in which a light emitting element is fixed between a first clamping jaw and a second clamping jaw so as to emit lights to an object directly, and the lights are not shielded by the first clamping jaw and the second clamping jaw.

### BACKGROUND OF THE INVENTION

To maintain a workpiece in a dim place, a worker grasps a flashlight with one hand and holds pliers with the other hand, thus causing inconvenient maintenance.

A conventional illumination structure for pliers is disclosed in TW Patent No. M352434 and contains an accommodation groove defined on a protective sleeve of a handle so as to connect with a casing. The casing is configured to house a light emitting element for emitting lights from two clamping jaws, and the casing has at least one battery housed therein and has a control button fixed thereon, such that the control button controls the light emitting element to electrically connect with the at least one battery, thus illuming the lights to the workpiece from the two clamping jaws.

However, the light emitting element is mounted on the two clamping jaws so after the two clamping jaws expand outwardly, they shield the lights.

The present invention has arisen to mitigate and/or obviate the afore-described disadvantages.

### SUMMARY OF THE INVENTION

The primary objective of the present invention is to provide an illumination structure for pliers in which a light emitting element is fixed between a first clamping jaw and a second clamping jaw so as to emit lights to an object directly, and the lights are not shielded by the first clamping jaw and the second clamping jaw.

To obtain the above objective, an illumination structure for pliers provided by the present invention contains: a first part, a second part, and an illumination device.

The first part includes a first clamping jaw, a first handle, and a first rotatable connecting portion defined between the first clamping jaw and the first handle.

The second part includes a second clamping jaw, a second handle, and a second rotatable connecting portion defined between the second clamping jaw and the second handle, wherein the first rotatable connecting portion of the first part and the second rotatable connecting portion of the second part are rotatably connected together.

The first rotatable connecting portion of the first part has an accommodation groove defined thereon so as to house the illumination device, and the accommodation groove has a first opening which communicates with the first clamping jaw and the second clamping jaw, the accommodation groove further has a second opening which is located proximate to and is in communication with the first handle, wherein the illumination device includes a light emitting element corresponding to the first opening and includes a control button corresponding to the second opening.

### BRIEF DESCRIPTION OF THE DRAWINGS

FIG. 1 is a perspective view showing the exploded components of an illumination structure for pliers according to a preferred embodiment of the present invention.

FIG. 2 is a perspective view showing the assembly of the illumination structure for the pliers according to the preferred embodiment of the present invention.

FIG. 3 is a cross sectional view showing the assembly of a part of the illumination structure for the pliers according to the preferred embodiment of the present invention.

FIG. 4 is a cross sectional view showing the operation of a part of the illumination structure for the pliers according to the preferred embodiment of the present invention.

### DETAILED DESCRIPTION OF THE PREFERRED EMBODIMENTS

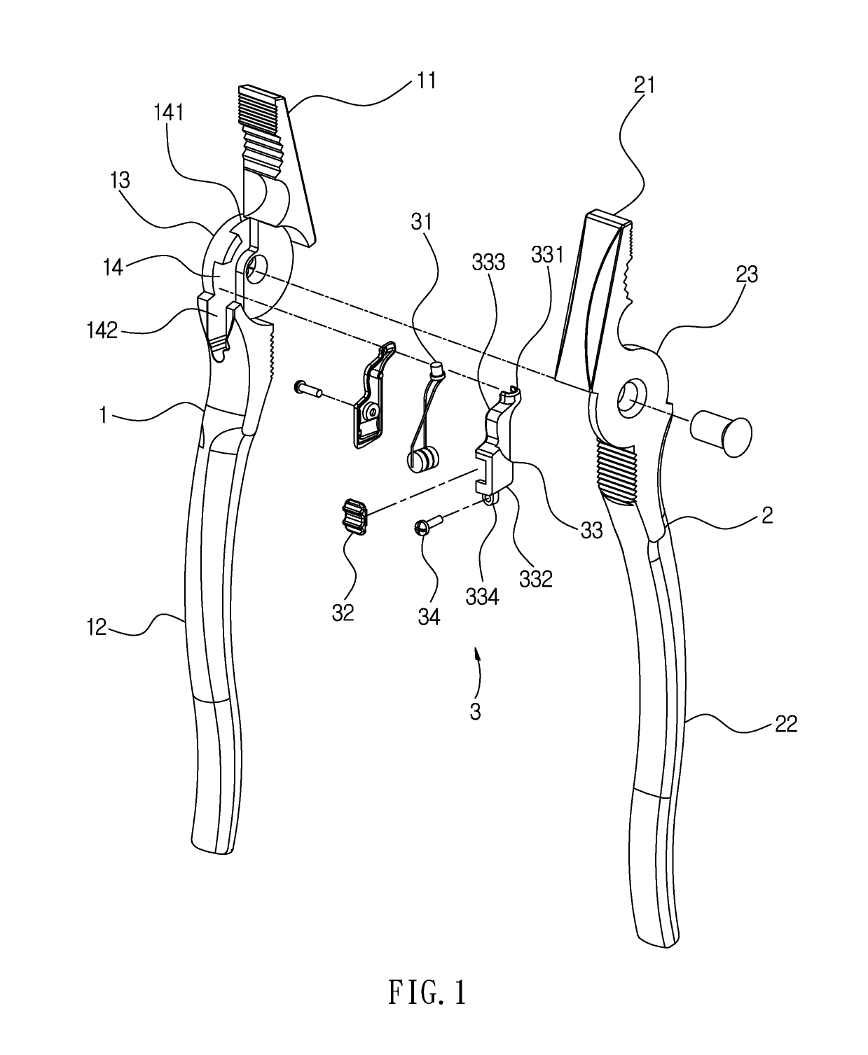

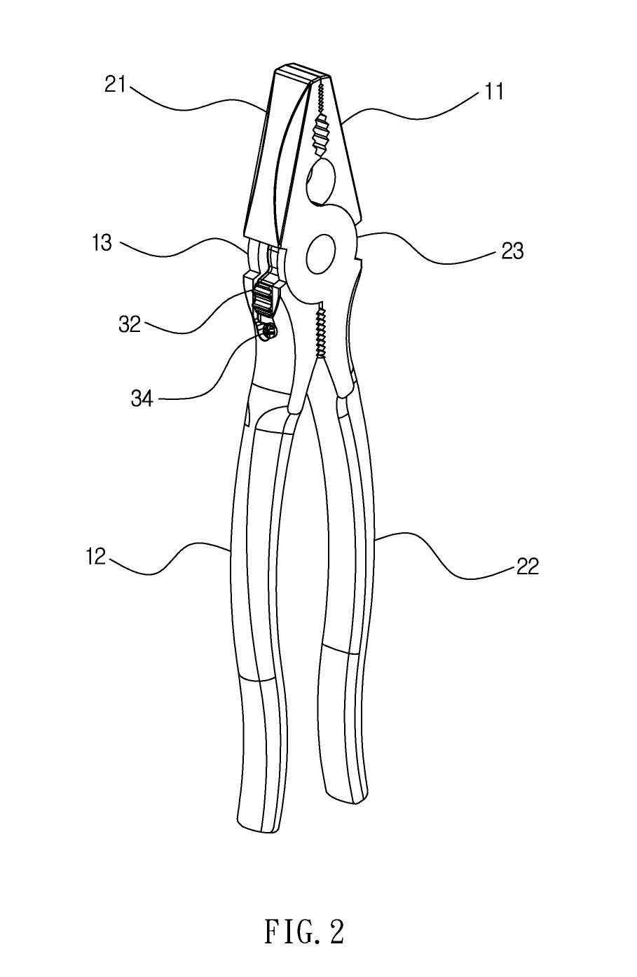

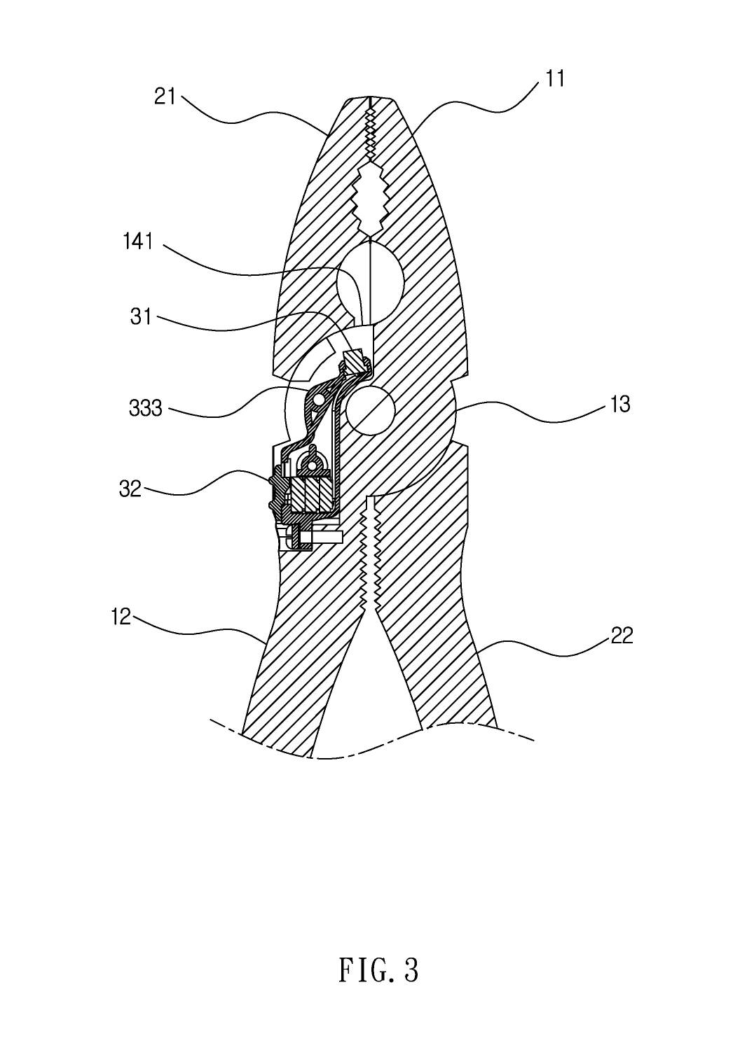

With reference to FIGS. 1 to 4, an illumination structure for pliers according to a preferred embodiment of the present invention is mounted on a connection area of a first part and a second part of the pliers so as to emit lights to an object from a first clamping jaw and a second clamping jaw. The illumination structure for the pliers comprises: the first part 1, the second part 2, and an illumination device 3.

The first part 1 includes the first clamping jaw 11, a first handle 12, and a first rotatable connecting portion 13 defined between the first clamping jaw 11 and the first handle 12. The second part 2 includes the second clamping jaw 21, a second handle 22, and a second rotatable connecting portion 23 defined between the second clamping jaw 21 and the second handle 22, wherein the first rotatable connecting portion 13 of the first part 1 and the second rotatable connecting portion 23 of the second part 2 are rotatably connected together. The first rotatable connecting portion 13 of the first part 1 has an accommodation groove 14 defined thereon so as to house the illumination device 3, and the accommodation groove 14 has a first opening 141 which communicates with the first clamping jaw 11 and the second clamping jaw 21, the accommodation groove 14 further has a second opening 142 which is located proximate to and is in communication with the first handle 12, wherein the illumination device 3 includes a light emitting element 31 corresponding to the first opening 141 and includes a control button 32 corresponding to the second opening 142.

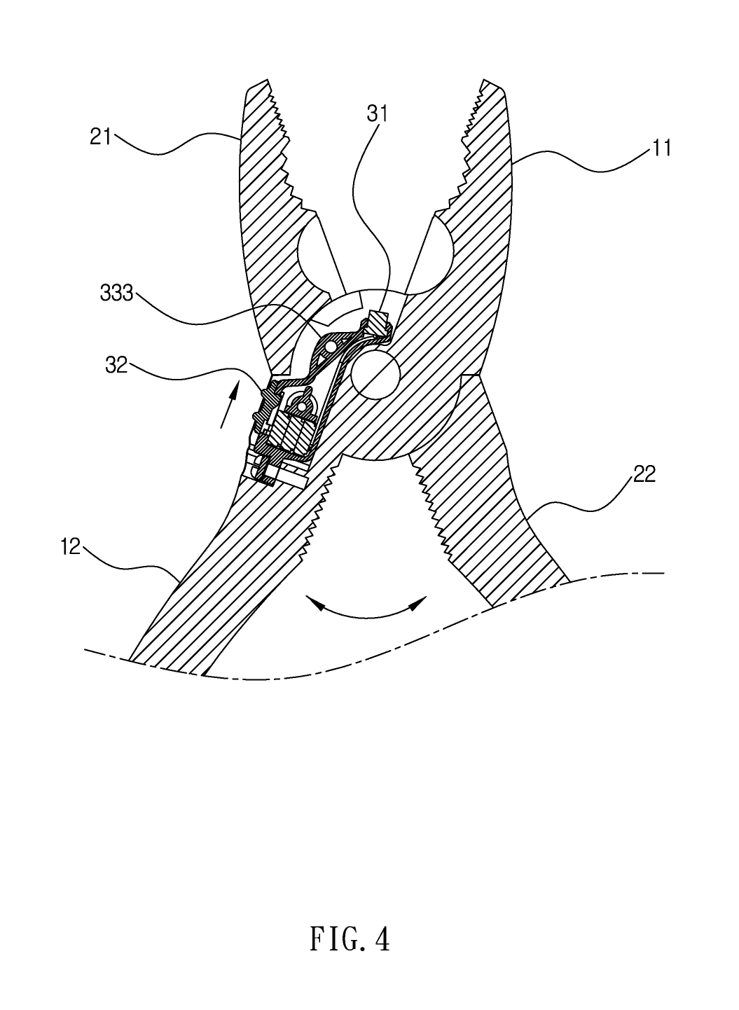

Thereby, the light emitting element 31 is fixed between the first clamping jaw 11 and the second clamping jaw 21 so as to emit the lights to the object directly, and the lights are not shielded by the first clamping jaw 11 and the second clamping jaw 21, as shown in FIG. 4.

The illumination device 3 also includes a coupling seat 33 fixed in the accommodation groove 14, and the coupling seat 33 has a first end portion 331 configured to extend the light emitting element 31 outwardly, and the coupling seat 33 also has a second end portion 332 on which the control button 32 slides, wherein between the first end portion 331 and the second end portion 332 of the coupling seat 33 is defined an arcuate section 333, and an area of the coupling seat 33 decreases from the second end portion 332 to the first end portion 331. A power supply system to the illumination device 3 is a well-known art, so further remarks are omitted. Preferably, related components of the illumination device 3 are connected together easily by way of the coupling seat 33, the coupling seat 33 is replaced quickly from the second opening 142, and the arcuate section 333 does not contact with a connection bolt of the first part 1 and the second part 2.

The coupling seat 33 further has a locking orifice 334 formed on the second end portion 332, and the illumination device 3 includes a fixing column 34 configured to lock the coupling seat 33 with the first part 1 through the locking orifice 334, such that the coupling seat 33 is connected with the first part 1 firmly by using the fixing column 34.

While the preferred embodiments of the invention have been set fourth for the purpose of disclosure, modifications of the disclosed embodiments of the invention and other embodiments thereof may occur to those skilled in the art. Accordingly, the appended claims are intended to cover all embodiments which do not depart from the spirit and scope of the invention.

What is claimed is:

1. An illumination structure for pliers comprising: a first part, a second part, and an illumination device; wherein
the first part includes a first clamping jaw, a first handle, and a first rotatable connecting portion defined between the first clamping jaw and the first handle;
the second part includes a second clamping jaw, a second handle, and a second rotatable connecting portion defined between the second clamping jaw and the second handle, wherein the first rotatable connecting portion of the first part and the second rotatable connecting portion of the second part are rotatably connected together;
the first rotatable connecting portion of the first part has an accommodation groove defined thereon so as to house the illumination device, and the accommodation groove has a first opening which communicates with the first clamping jaw and the second clamping jaw, the accommodation groove further has a second opening which is located proximate to and is in communication with the first handle, wherein the illumination device includes a light emitting element corresponding to the first opening and includes a control button corresponding to the second opening.

2. The illumination structure for the pliers as claimed in claim 1, wherein the illumination device also includes a coupling seat fixed in the accommodation groove, and the coupling seat has a first end portion configured to extend the light emitting element outwardly, and the coupling seat also has a second end portion on which the control button slides, wherein between the first end portion and the second end portion of the coupling seat is defined an arcuate section, and an area of the coupling seat decreases from the second end portion to the first end portion.

3. The illumination structure for the pliers as claimed in claim 2, wherein the coupling seat further has a locking orifice formed on the second end portion, and the illumination device includes a fixing column configured to lock the coupling seat with the first part through the locking orifice.
